(19) United States
(12) Patent Application Publication
(10) Pub. No.: US 2015/0028237 A1
(43) Pub. Date: Jan. 29, 2015

(54) SOLENOID VALVE

(71) Applicants: Cheng Liu, Tianjin (CN); Jinhong Qiao, Tianjin (CN); Changdong Wang, Tianjin (CN); Weiwei Jiang, Tianjin (CN)

(72) Inventors: Cheng Liu, Tianjin (CN); Jinhong Qiao, Tianjin (CN); Changdong Wang, Tianjin (CN); Weiwei Jiang, Tianjin (CN)

(73) Assignee: Danfoss Tianjin Ltd., Tianjin (CN)

(21) Appl. No.: 14/369,433

(22) PCT Filed: Jul. 11, 2012
(86) PCT No.: PCT/CN2012/078494

§ 371 Date: Sep. 30, 2014

(30) Foreign Application Priority Data
Dec. 31, 2011 (CN) 201110459124.2

(51) Int. Cl. F16K 31/06

(52) U.S. Cl. CPC F16K 31/0655
USPC 251/129.2; 251/129.15

(57) ABSTRACT

The present invention discloses a solenoid valve, it comprises: a movable core, provided with a flange at a lower end thereof; a driving assembly, in which the flange will abut against a bottom portion thereof and can move up against an upper portion thereof within a chamber of the driving assembly; a piston assembly, a central part of which seals a valve port of the solenoid valve, a periphery of which seals an annular chamber formed between the valve port and a valve body of the solenoid valve, the annular chamber being communicated to the inlet connection pipe, the piston assembly being disposed with a conducting hole at a center thereof, which is sealed by the bottom of the driving assembly; when opening the valve port, the flange of the movable core will first be moved to abut against the upper portion of the driving assembly, and then drive the driving assembly to move up in order to open the conducting hole, wherein since flow of fluid from an upper chamber above the piston assembly into an valve body outlet chamber below the piston assembly through the conducting hole via the valve port is larger than flow of fluid into the upper chamber from an inlet connection pipe of the solenoid valve, an upward force of pressure difference is generated on the piston assembly so that such upward force will enable the piston assembly to move up, thereby opening the valve port.

### CROSS-REFERENCE TO RELATED APPLICATION

This application claims the benefit of Chinese Patent Application No. 201110459124.2 filed on Dec. 31, 2011 in the State Intellectual Property Office of China, and International Patent Application No. PCT/CN2012/078494 filed Jul. 11, 2012, the disclosures of which are incorporated herein by reference.

### BACKGROUND OF THE INVENTION

1. Field of the Invention

The present invention relates to a field of valve control switch, more particularly, to a solenoid valve and a driving assembly therefor.

2. Description of the Related Art

As R410A refrigerant is widely used, pressure in a system using it is increased, and thus there is a higher demand on an opening valve ability of the solenoid valve. Therefore, a key factor is how to improve a highest operating pressure difference in the solenoid valve. Accordingly, it is needed to optimize interior structures of the solenoid valve and greatly improve the operational performance of the solenoid valve, so as to satisfy requirement on the system due to the R410A refrigerant.

In order to increase the highest operating pressure difference, three main solutions currently can be found from the prior art.

A first solution is to increase diameters of movable and fixed cores attracting with each other, and thus the operational performance of the solenoid valve can be increased by increasing the attracting area thereof.

A second solution is to increase power of coil and thus the operational performance of the solenoid valve can be increased by increasing magnetic field intensity.

A third solution is to utilize a small gap and to obtain a small impulse, for improving the operational performance of the solenoid valve. However, the effect obtained by this solution is limited.

Apparently, although the above three solutions all can achieve the aim of increasing the operational performance of the solenoid valve, the disadvantages of the first and second solutions lie in that the operational performance of the solenoid valve is increased by increasing cost of the solenoid valve, and the effect obtained by the third solution is limited on terms of improving the operational performance.

In view of the above, there is indeed a need for a new solenoid valve, which can greatly improve the highest operational pressure difference of the solenoid valve, under the circumstance of the coil therein consuming the same power, thereby satisfying the requirement of new refrigerant on the solenoid valve system.

### SUMMARY OF THE INVENTION

Bearing in mind of the above shortages in prior arts, an object of the present invention is to alleviate at least one aspect of the above problems and defects.

Accordingly, one object of the present invention is to provide a new solenoid valve, which can greatly improve the highest operational pressure difference of the solenoid valve, under the circumstance of the coil therein consuming the same power, thereby satisfying the requirement of new refrigerant on the solenoid valve system.

In one aspect of the present invention, there is provided a solenoid valve, comprising:

a movable core, provided with a flange at a lower end thereof;
a driving assembly, in which the flange will abut against a bottom portion of the driving assembly and can move within a chamber of the driving assembly until it abuts against an upper portion thereof;
a piston assembly, a central part of which seals a valve port of the solenoid valve, and a periphery of which seals an annular chamber formed between the valve port and a valve body of the solenoid valve, the annular chamber being communicated to an inlet connection pipe, the piston assembly being disposed with a conducting hole at a center thereof, the conducting hole being sealed by the bottom of the driving assembly;
when opening the valve port, the flange of the movable core will first be moved to abut against the upper portion of the driving assembly, and then drive the driving assembly to move up in order to open the conducting hole, wherein since flow of fluid from an upper chamber above the piston assembly into an valve body outlet chamber below the piston assembly through the conducting hole via the valve port is larger than flow of fluid into the upper chamber from an inlet connection pipe of the solenoid valve, an upward force of pressure difference is generated on the piston assembly so that such upward force will enable the piston assembly to move up, thereby opening the valve port.

Preferably, a seal member is disposed on a bottom portion of the driving assembly at a center thereof, for sealing the conducting hole; and the bottom portion of the driving assembly is a circular bottom plate, which is provided with a plurality of grooves spaced apart along an outer periphery thereof and a plurality of protrusions between the adjacent grooves.

Preferably, a top plate of the driving assembly has a smaller diameter than the bottom plate, and is an arc-shaped flat plate, and the top plate is integrated with the bottom plate by a vertical wall, so as to form a cylindrical chamber with a portion thereof being cut away at one side thereof.

Preferably, an opening is provided at a center of the top plate, a top of the opening is in an arc shape, and two sides of the opening are vertical, and two sides of the vertical wall are internally cut so as to form flat straight sides at the interior of the vertical wall, for receiving and connecting with the flange of the movable core.

Preferably, the seal member is a hemisphere used for sealing the conducting hole, a spherical surface of the hemisphere is cooperated with the conducting hole, and a large circular surface or a bottom surface of the hemisphere passing through an center thereof is in the same horizontal plane as a plane of the bottom plate, and a plurality of ventholes spaced apart are provided along a circumference of the circular surface or the bottom surface.

Preferably, the driving assembly is integrally or separately made of plastics.

Preferably, the piston assembly is of an integral type, an upper part of which is provided with an annular slot at a central part thereof, while a lower portion thereof is arranged with a boss, or a groove inwardly recessed, an outer surface of which is provided with a plurality of tooth slots, and fluid flows into the valve body of the solenoid valve through a gap between the tooth slots and the valve seat of the solenoid valve.

Preferably, when the seal member of the driving assembly seals the conducting hole of the piston assembly, the boss of the piston assembly or a portion of the bottom surface of the piston assembly and the groove will be fitted on the annular central step disposed within the chamber of the valve body, so that the piston assembly seals the valve port.

Preferably, a bottom surface of the piston assembly is provided with an inclined surface which gradually rises from inside to outside. When the seal member of the driving assembly seals the conducting hole of the piston assembly, since the bottom surface of the piston assembly is inclined, only a portion of the bottom surface of the piston assembly abuts against the annular central step arranged in the chamber of the valve body, and an outside portion of the bottom surface of the piston assembly abuts against the annular central step, and thus the piston assembly seals the valve port.

Preferably, the piston assembly is of separate type, and includes a piston body and a seal plug which can be assembled together to be movable relative to each other.

Preferably, a central chamber of the piston body is a two-stage cylindrical step chamber, an upper step chamber of which has a larger diameter than a lower step chamber of the two-stage cylindrical step chamber, wherein the seal plug is a cylinder with a protrusion at an upper portion. The protrusion has an outer diameter larger than the diameter of the lower step chamber and less than the diameter of the upper step chamber, so that the protrusion can be locked within the two-stage cylindrical step chamber.

Preferably, the seal plug can be moved up within the central chamber of the piston body along a central axis thereof, a distance between an upper end face of the seal plug and an upper end face of the piston body is a first distance so that an annular groove is formed within an upper portion of the piston assembly, and a bottom portion of the seal plug is protruded from the central chamber of the piston body by a second distance to form a boss, or is recessed inwardly by a second distance to form a groove.

Preferably, an outer surface of the piston body is provided with a plurality of tooth slots, fluid flows into the valve body of the solenoid valve through a gap between the tooth slots and the valve seat of the solenoid valve, and a bottom surface of the piston body is provided with an inclined surface which gradually rises from an inside to an outside.

Preferably, when the seal member of the driving assembly seals the conducting hole of the seal plug, since the bottom surface of the piston body is inclined, only a portion of the bottom surface of the piston body abuts against the annular central step arranged in the chamber of the valve body, and an outside portion of the bottom surface of the seal plug abuts against the annular central step, and thus the seal plug seals the valve port.

Preferably, the annular valve port is formed within the valve body by arrangement of the annular central step in the valve body, the annular chamber is formed between the annular central step and the body of the valve seat, and the piston body covers on the annular chamber, which is communicated to the inlet connection pipe of the solenoid valve.

Preferably, when the conducting hole of the seal plug is opened, since flow into the upper chamber above the piston body through the gap between the tooth slots and the valve seat is less than flow into the body outlet chamber below the piston assembly and a chamber of the outlet connection pipe from the upper chamber through the conducting hole, the upper chamber becomes a low pressure chamber, and the annular chamber becomes a high pressure chamber due to communicating to the chamber of the inlet connection pipe of the solenoid valve, thereby an upward force of pressure difference is generated on the piston body, the upward force drives the piston body to move up until it abuts against the protrusion of the seal plug, and then drives the seal plug and the piston body to move up together, until the valve port is finally opened.

Preferably, the solenoid valve further comprises: a valve body having a fixed core, a sleeve, the movable core, a valve seat, the driving assembly, the piston assembly, and the inlet and outlet connection pipes cooperated with each other; and a coil, disposed outside of the valve body corresponding to the fixed core, and capable of generating a magnetic force for attracting the movable core to move up, when being energized.

Preferably, the valve seat is tightly connected to the sleeve by a seal cap arranged thereon and a seal ring provided at a bottom portion of the sleeve; the movable core is movably disposed within the sleeve, the valve seat is provided with the valve port, and the piston assembly seals the valve port of the valve seat, by which the inlet and outlet connection pipes are in fluid communication with the chamber of the valve seat.

Preferably, a return spring is provided within a chamber of the movable core, one end of the return spring is positioned in the chamber of the movable core, while the other end thereof is protruded from the chamber of the movable core and is contacted or fixed with a bottom surface of the fixed core, and a distance by which the movable core moves until it contacts with the fixed core is a first travel.

Preferably, a distance by which the flange of the movable core moves within the chamber of the driving assembly from the bottom thereof until it abuts against the top of the chamber is a second travel, and the second travel is less than the first travel.

### BRIEF DESCRIPTION OF THE DRAWINGS

Those and/or other aspect and advantages of the present invention can be apparent and readily understood from the following description of the preferred embodiment, in combination with the accompanying drawings, wherein:

FIG. 1 schematically shows a sectional view of a solenoid valve in accordance with an embodiment of the present invention;

FIG. 2 is an enlarged schematic view of a part A as shown in FIG. 1;

FIG. 3 is an enlarged schematic view of a driving assembly as shown in FIG. 1;

FIG. 4 is a schematic view showing a state in which a flange of a movable core in the solenoid valve shown in FIG. 1 has moved to contact a top plate of the driving assembly;

FIG. 5 is a schematic view showing a state in which a valve port of the solenoid valve as shown in FIG. 1 is open; and

FIG. 6 is a schematic sectional structure view of a piston assembly as shown in FIG. 1.

### DETAILED DESCRIPTION OF THE EMBODIMENTS

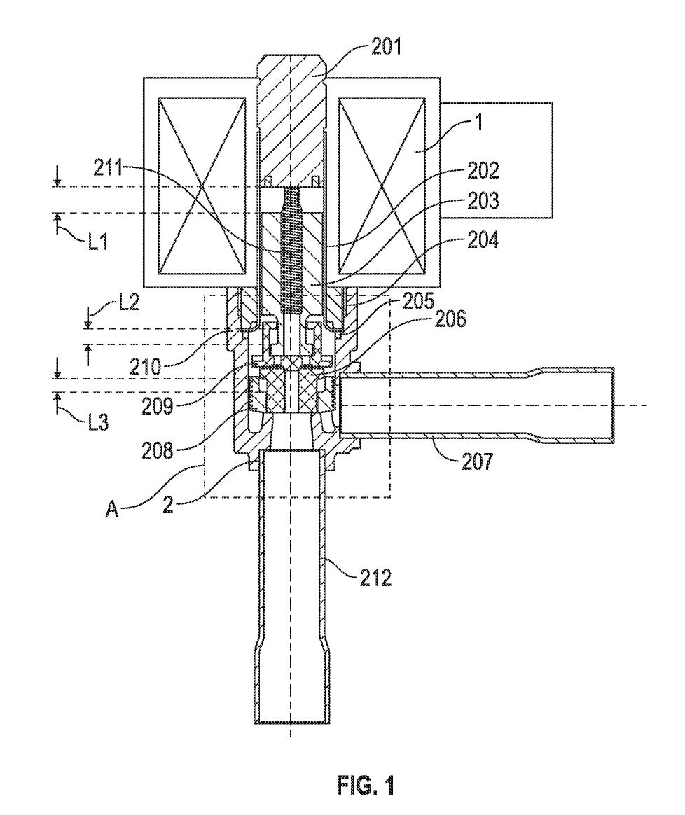

The technical solution of the present invention will be further explained in detail, by the following embodiments, with reference to FIGS. 1-6. Throughout the specification, the same or similar reference numerals will indicate the same or similar components. The explanation to the implementing of the present invention with reference to the accompanying drawing is intended to interpret the general inventive concept of the present invention, instead of limiting the present invention.

A solenoid valve in accordance with an embodiment of the present invention is now explained with referring to the accompanying drawings.

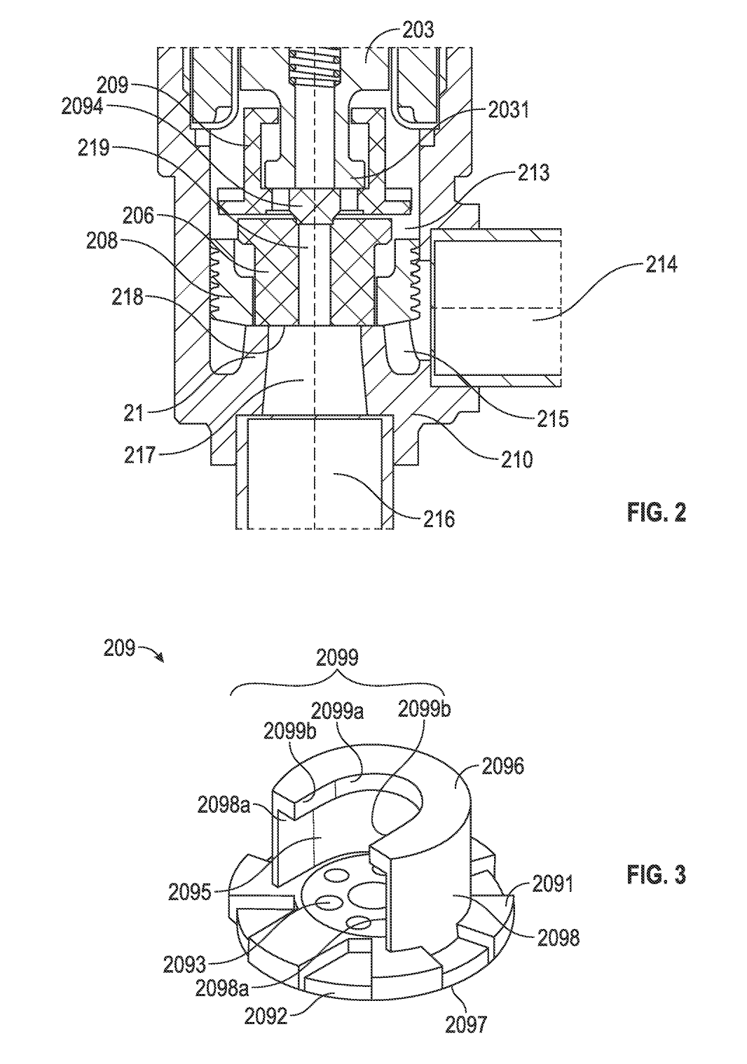

As shown in FIGS. 1 and 2, they illustrate a solenoid valve in accordance with a first embodiment of the present invention. The solenoid valve comprises: a movable core 203, a lower end of which is provided with a flange 2031; a driving assembly 209, in which the flange 2031 can abut against a bottom of the driving assembly 209 and move within a chamber 2095 of the driving assembly 209 until it abuts against an upper part of the driving assembly 209; a piston assembly 220, a central part of which seals a valve port 218 of the solenoid valve and a peripheral part of which seals or covers an annular chamber 215 arranged between the valve port 218 and a valve body 2 of the solenoid valve, the annular chamber 215 being communicated with an inlet connection pipe 207. A conducting hole 219 is provided at a center of the piston assembly 220 (see FIG. 6). A bottom of the driving assembly 209 (i.e., a sealing member 2094) seals the conducting hole 219. When opening the valve port 218, the flange 2031 of the movable core 203 is first moved up until it abuts against an upper part of the driving assembly 209, and then the driving assembly 209 is driven by the flange 2031 to move up so as to open the conducting hole 219. Since flow of fluid from an upper chamber 213 above the piston assembly 220 into a body outlet chamber 217 below the piston assembly 220 through the conducting hole 219 via the valve port 218 is larger than flow of fluid into the upper chamber 213 from the inlet connection pipe 207 of the solenoid valve, an upward force of pressure difference is generated on the piston assembly 220. Therefore, the piston assembly 220 is moved up by the upward force, thereby opening the valve port 218.

Specifically, upon opening the conducting hole 219, since flow of fluid from the upper chamber 213 above the piston assembly 220 into the body outlet chamber 217 below the piston assembly 220 through the conducting hole 219 via the valve port 218 is larger than flow of fluid into the upper chamber 213 from the inlet connection pipe 207 of the solenoid valve. At this time, the upper chamber 213 is under a low pressure while the annular chamber 215 is under a high pressure due to communicating to the inlet connection pipe 207, thereby an upward force of pressure difference being generated on the piston assembly 220. As shown in FIG. 1, a shape of the annular chamber 215 can be shaped to be irregular. That is, the bottom and sides of the annular chamber 215 can have a certain curvature or inclination angle. As described in detail later, the above arrangement of the annular chamber 215 can be mated with an inclined surface 2084 of a piston body 208, so as to facilitate creation of the pressure difference on the piston body 208.

As one example, the present solenoid valve further comprises a coil 1 and a valve body 2. The valve body 2 includes a fixed core 201, a sleeve 202, a movable core 203, a return spring 211, a seal cap 204, a seal ring 205, a valve seat 210, the driving assembly 209, a seal plug 206, a piston body 208, the inlet connection pipe 207 and the outlet connection pipe 212 cooperated with each other. The coil 1 is dispose outside of the valve body 2 corresponding to the fixed core 201, and thus when the coil is energized, it can generate magnetic force for attracting the movable core 203 to move up. The coil 1 is attached to the valve body 2 by a circlip (not shown) on the coil 1.

The valve seat 210 is tightly connected to the sleeve 202 by the seal cap 204 arranged thereon and the seal ring 205 provided at the bottom of the sleeve 202. The movable core 203 is movably disposed within the sleeve 202, and the valve seat 210 is provided with the valve port 218. The piston assembly 220 (in the present embodiment, the central part of the piston assembly 220) seals the valve port 218 of the valve seat 210. The inlet connection pipe 207 and the outlet connection pipe 212 are in fluid communication with the chamber of the valve seat 210 via the valve port 218. In the present embodiment, the inlet connection pipe 207 is disposed along a horizontal direction of FIG. 1 and communicated to the annular chamber 215. The outlet connection pipe 212 is disposed along a vertical direction of FIG. 1 and communicated with the body outlet chamber 217 at a bottom of the valve seat 210.

The return spring 211 is provided within the chamber of the movable core 203. One end of the return spring 211 is in the chamber of the movable core 203, while the other end thereof is protruded from the chamber of the movable core 203 and is contacted or fixed with a bottom surface of the fixed core 201. A first travel L1 is a distance by which the movable core 203 moves until it contacts with the fixed core 201. It should be understood that the return spring 211 of the present invention can be arranged to be interposed between the movable core 203 and the fixed core 201 without being permanently connected. Alternatively, the return spring can be arranged so that one end thereof is permanently connected to or abutted against the movable core 203, while the other end is permanently connected to or abutted against the fixed core 201.

In addition, as shown in FIGS. 1 and 3, a second travel L2 is a distance by which the flange 2031 of the movable core 203 moves within the chamber 2095 of the driving assembly 209 from the bottom of the chamber 2095 until it abuts against the top of the chamber 2095. The second travel L2 is less than the first travel L1. It should be understood that the second travel L2 must be less than the first travel L1 so that when the fixed core 201 is attracted together with the movable core 203, the driving assembly 209 is driven by the movement of the movable core 203, so as to open the conducting hole 219.

As shown in FIG. 3, focus will now be placed on the structure arrangement of the driving assembly 209 of the present invention.

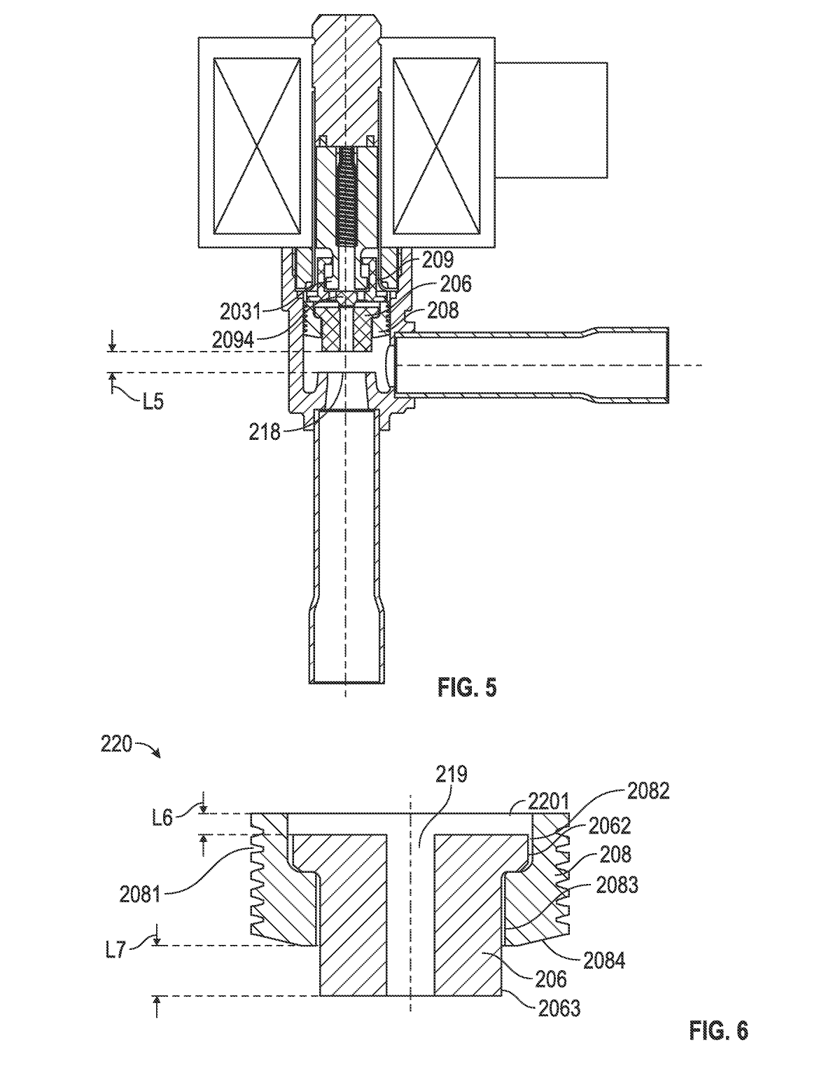

The driving assembly 209 is integrally or separately made of plastic or other plastic materials having a relatively high tensile strength. In the present invention, the driving assembly 209 is a plastic piece which is integrally made of plastic. The bottom of the driving assembly 209 is a circular bottom plate 2097. A plurality of grooves 2092 are spaced apart and provided along an outer periphery of the bottom plate 2097, and a plurality of lug bosses 2091 each are arranged between the adjacent grooves 2092. The person skilled in the art should know that the arrangement of the lug boss 2091 can function to limit position during upwardly moving the driving assembly 209. In other words, when the lug boss 2091 is moved to contact the bottom of the sleeve 202 as shown in FIG. 5, it functions to stop the driving assembly 209 from moving up.

The top plate 2096 of the driving assembly 209 has a less diameter than the bottom plate 2097, and is an arc-shaped flat plate. The top plate 2096 is integrally connected with the bottom plate 2097 by a vertical wall 2098, so as to form a cylindrical chamber 2095 with one part thereof being cut away at one side. The top plate 2096 is disposed with an opening 2099 at the centre thereof. A top 2099a of the opening 2099 is arc-shaped while two sides 2099b of the opening 2099 are vertical. Two interior sides of the vertical wall 2098 are cut for forming flat straight sides 2098a at the interior of the vertical wall 2098, thereby facilitating receiving and connecting of the flange 2031 of the movable core 203. It should be understood that the cut at an upper side of the driving assembly 209 can ensure the driving assembly 209 cooperates with the flange 2031 of the movable core 203, i.e., the driving assembly 209 receives the flange 2031 as shown in FIG. 2. The seal member 2094 is provided on the bottom of the driving assembly 209 at a center thereof. The seal member 2094 is a hemisphere for sealing the conducting hole 219. The spherical surface of the hemisphere is cooperated with the conducting hole 219. A large circular surface or bottom surface of the hemisphere passing through the center thereof is in the same horizontal plane as a plane of the bottom plate 2097, and a plurality of ventholes 2093 spaced apart are provided along a circumference of the circular surface or the bottom surface. Specifically, any suitable number of ventholes 2093 can be arranged in the present invention, for example, 5 or 7. The grooves 2092 and the ventholes 2093 can function to balance the circulation.

Of course, the person skilled in the art should understand that the driving assembly 209 can be provided with any other forms, as long as the flange 2031 can be movably received within the chamber of the driving assembly 209.

As shown in FIG. 6, in one embodiment of the present invention the piston assembly 220 of the solenoid valve is of separate or discrete type. The piston assembly 220 includes a piston body 208 and a seal plug 206 which can be assembled together to be movable relative to each other. The central chamber of the piston body 208 is a two-stage cylindrical step chamber, the upper step chamber 2082 of which has a larger diameter than the lower step chamber 2083 of the two-stage cylindrical step chamber. The seal plug 206 is a cylinder with a protrusion 2062 at an upper portion, and the protrusion 2062 has an outer diameter larger than the diameter of the lower step chamber 2083 and less than the diameter of the upper step chamber 2082, so that the protrusion 2062 can be locked or fitted within the two-stage cylindrical step chamber.

Further, the seal plug 206 can be moved up along the central axis of the piston body 208 within the central chamber thereof. A first distance L6 (which can function to circulate fluid) is a distance between an upper end face of the seal plug 206 and an upper end face of the piston body 208, so that an annular groove 2201 is formed above the piston assembly 220. The bottom of the seal plug 206 is protruded from the central chamber of the piston body 208 by a second distance L7, to form a boss 2063. In the present embodiment, the second distance L7 is larger than the first distance L6. However, the person skilled in the art should understand that there is not a necessary relationship between the first and second distances L6 and L7 on terms of size. In other words, the second distance L7 can be less than or equal to the first distance L6, as long as it can ensure that the seal member 2094 seals the conducting hole 219 and the piston assembly 220 seals the valve port 218.

In addition, although the piston assembly 220 of the present embodiment has the boss 2063, an inward step or groove can be formed by the seal plug 206 and the piston body 208, i.e., the bottom surface of the seal plug 206 is above the bottom surface of the piston body 208. It should be noted that in this case, the shape of the annular central step 21 cooperated with them may be modified, so as to tightly fit with the bottom surfaces of the seal plug 206 and the piston body 208, and the seal member 2094 seals the conducting hole 219 of the seal plug 206, so that the valve port 218 and the conducting hole 219 can be sealed at the same time.

Furthermore, an outer surface of the piston body 208 is provided with a plurality of tooth slots 2081, and thus the fluid can flow into the valve body 2 of the solenoid valve (finally into the upper chamber 213) through a gap between the tooth slots 2081 and the valve seat 210 of the solenoid valve. A bottom surface of the piston body 208 is provided with an inclined surface 2084, which gradually rises from an inside to an outside. When the seal member 2094 of the driving assembly 209 seals the conducting hole 219 of the seal plug 206, since the bottom surface of the piston body 208 is inclined, only a portion of an inside part of the bottom surface of the piston body 208 abuts against the annular central step 21 disposed in the chamber of the valve body 2, and a portion of an outside part of the bottom surface of the seal plug 206 abuts against the annular central step 21, and thus the seal plug 206 seals the valve port 218. Specifically, with referring to FIG. 2, the annular valve port 218 is formed within the valve seat 210 by arrangement of the annular central step 21, while the annular chamber 215 is formed between the central step 21 and the body of the valve seat 210. The annular chamber 215 is communicated with the inlet connection pipe 207, and a portion of the inside of the inclined surface 2084 abuts against the annular central step 21 or central flange 21. It is helpful to arrange the bottom surface of the piston body 208 as the inclined surface 2084 so that intermediately after opening the conducting hole 219, an upward force of pressure difference is generated on the piston body 208 to push the piston body 208 to move up (which will be described in detail within the working principle part). Referring to FIG. 1, it can be known that the inclined surface 2084 will cooperate with the annular chamber 215 or seal the annular chamber 215. At this time, since the annular chamber 215 is communicated with the inlet connection pipe 207, it is in a high pressure. When opening the conducting hole 219, since the fluid in the upper chamber 213 is gradually reduced, the upper chamber 213 becomes a low pressure chamber. Therefore, there is a pressure difference generated on the piston body 208. The person skilled in the art can appreciate that the arrangement of the inclined surface 2084 facilitates generation of the pressure difference.

When the conducting hole 219 of the seal plug 206 is opened, since the flow into the upper chamber 213 above the piston body 208 through the gap between the tooth slots 2081 and the valve seat 210 is less than that into the body outlet chamber 217 below the piston assembly 220 and the chamber 216 of the outlet connection pipe 212 from the upper chamber 213 through the conducting hole 219, as described previously, the upward force of pressure difference is generated on the piston body 208. The piston body 208 will be driven by the upward force to move up until it abuts against the protrusion 2062 of the seal plug 206, and then the seal plug 206 and the piston body 208 will be moved up together, until the valve port 218 is finally opened.

Hereinbelow, the operational principle about a close state and an open state of the solenoid valve of the first embodiment in accordance with the present invention will be explained and analyzed.

The operational state of the solenoid valve can be expressed as a cycle of opening and closing states of the solenoid valve, which can be achieved by energizing or de-energizing the coil 1. The cycle is from a closing state, through an opening state, to a closing state, which is continuously repeated.

I. The closing state (as shown in FIG. 1): when the coil 1 is not energized, the inlet connection pipe 207 of the valve body 2 is not provided with fluid or high pressure fluid. Under the effect of the return spring 211, the movable core 203 tightly presses the driving assembly 209, which in turn seals the conducting hole 219. Further, the seal plug 206 seals the valve port 218. At this time, the solenoid valve is in the closing state.

When the high pressure fluid flows into the inlet connection pipe 207 of the valve body 2, it will flows into the upper chamber 213 through the gap between the tooth slots 2081 of the piston body 208 and the valve seat 210, thus being accumulated within the upper chamber 213.

With respect to the driving assembly 209: the top plate 2096 of the driving assembly 209 is within the upper chamber 213, and thus lies under a high pressure. The portion of the bottom plate 2097 of the driving assembly 209 which seals the conducting hole 219, is connected with a low pressure side through the body outlet chamber 217 below the portion and the chamber 216 of the outlet connection pipe 212. Thus, the portion as described above lies under a low pressure. Therefore, a downward force of pressure difference is generated onto the top and bottom plates 2096, 2097 of the driving assembly 209. The driving assembly 209 seals the conducting hole 219 under the effect of the above force of pressure difference and the spring force of the return spring 211.

With respect to the seal plug 206: since the upper surface of the seal plug 206 is within the upper chamber 213, it lies under a high pressure. A portion of the lower surface of the seal plug 206 which seals the valve port 218, is connected with a low pressure side through the body outlet chamber 217 below the portion and the chamber 216 of the outlet connection pipe 212. Thus, the portion as described above lies under a low pressure. Therefore, a force of pressure difference, which is directed downwardly, is generated on the upper and lower surfaces of the seal plug 206. The seal plug 206 seals the valve port 218 under the effect of the above force of pressure difference and the spring force of the return spring 211. Finally, the solenoid valve is in the closing state.

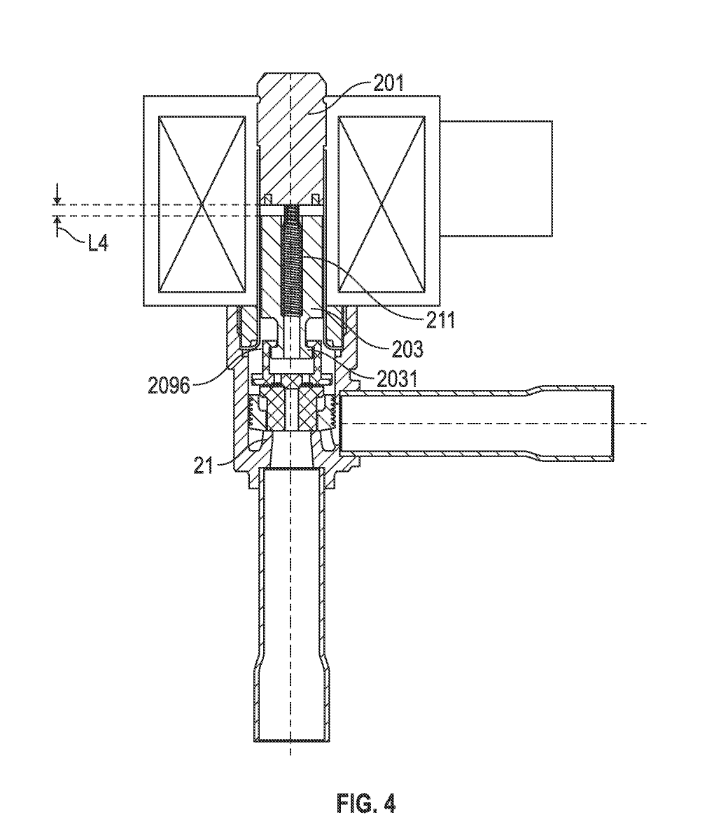

II. The opening state: When the coil 1 is energized, the movable core 203 will move toward the fixed core 201 against itself gravity and the spring force of the return spring 211 with the aid of a magnetic force. At this time, the movable core 203 will be accelerated to move up by the magnetic force and the spring force of the return spring 211. When the movable core 203 is moved so that a distance between the movable core 203 and the fixed core 201 is L4 or a moving distance of the flange 2031 is L2 (as shown in FIG. 4), the movable core 203 per se, will get a very high momentum. At this time, the movable core 203 will overcome the force of pressure difference acting on the driving assembly 209, under the effect of the high momentum and the magnetic force; and drive the driving assembly 209 to move up, thereby opening the conducting hole 219. After the conducting hole 219 is opened, the high pressure fluid in the upper chamber 213 will flow out through the conducting hole 219, the valve port 218 and the outlet connection pipe 212. Since an area of the gap between the inner chamber of the valve seat 210 and the piston body 208 is designed to be less than that of the conducting hole 219, the high pressure fluid in the upper chamber 213 will completely flow out and thus the upper chamber 213 will become a low pressure chamber.

At this time, with regard to the piston body 208: the upper surface of the piston body 208 lies within the upper chamber 213 which has been under a low pressure; and thus it lies under the low pressure. In contrast, the lower side of the piston body 208 is positioned within the annular chamber 215 which is communicated with the chamber 214 of the inlet connection pipe 207 containing the high pressure fluid, and thus lies under a high pressure. Therefore, an upward force for the pressure difference will be generated between the upper and lower sides of the piston body 208. Upon being subjected to such upward force, the piston body 208 will be accelerated to move up. After upwardly moving a distance L3 under the effect of such force of the pressure difference, the piston body 208 will drive the seal plug 206 for moving up, to open the valve port 218 and finally the solenoid valve (as shown by FIG. 5).

During such moving, the driving assembly 209 will sever as “a connecting link between the preceding and the following”. That is, when the movable core 203 is moved toward the fixed core 201 by the attraction of the magnetic force, initially, what needed is only to attract the movable core 203 to move up. After the movable core 203 moves a certain distance and has a relatively large momentum, it will drive the driving assembly 209 to move up together; thereby opening the conducting hole 219. Then, the piston body 208 will be pushed to move up by a upward force of pressure difference which is generated on the piston body 208; and after the piston body 208 is moved up by a distance L3 and gets a relatively large momentum, it will drive the seal plug 206 to move up together, finally opening the valve port 218. Therefore, since the movable core 203 and the piston body 208 all are used to open the conducting hole 219 and the valve port 218 at the moment that they get a very large momentum, the power of the coil 1 of the solenoid valve is relatively small, as compared with that of the coil in the conventional solenoid valve having the direct lifting valve structure.

It should be noted that when upwardly moving the driving assembly 209, the small boss 2091 are used to limit position, and the grooves 2092 and the holes 2093 function to balance the fluid circulation.

III. The closing state: when the coil 1 is de-energized, the movable core 203 will be detached apart from the fixed core 201 and moved downwardly under the effect of the its own gravity and the spring force of the return spring 211. After shifting a certain distance, the movable core 203 will push the driving assembly 209 to downwardly move together and to seal the conducting hole 219. At this time, the high pressure fluid will be accumulated again within the upper chamber 213. In this case, with respect to the seal plug 206: the upper surface of the seal plug 206 is in the high pressure chamber 213, and under a high pressure. The lower surface of the seal plug 206 is communicated to the outlet connection pipe 212 via the annular chamber 215, and the body outlet chamber 217 below the seal plug 206, and thus being under a low pressure. Therefore, a downward force of pressure difference will be generated between both upper and lower sides of the seal plug 206. The seal plug 206 will push the piston body 208 to move downwardly together under the effect of the spring force of the return spring 211 and such force of pressure difference, until the valve port 218 is finally sealed. At this time, the valve port 218 and the conducting hole 219 are closed and thus the solenoid valve is closed.

### Second Embodiment

The second embodiment of the present invention provides another solenoid valve, which has the following differences from the first embodiment in that the piston assembly is an integral member or of integral type. Since other parts of the solenoid valve, except the piston assembly, are the same as the first embodiment, they are omitted for sake of conciseness.

As described above, the piston assembly of the second embodiment is an integral member. An upper part of the piston assembly is provided with an annular slot at the central part thereof, while the lower portion of the piston assembly is arranged with a boss. Further, a plurality of tooth slots are disposed on an outer surface of the piston assembly, and thus fluid will flow into the valve body of the solenoid valve through the gap between the tooth slots and the valve seat of the solenoid valve. When the seal member of the driving assembly seals the conducting hole of the piston assembly, the boss of the piston assembly will abut against the annular central step disposed within the chamber of the valve body, and thereby the piston assembly will seal the valve port. As described above for the piston assembly of separate type, the bottom of the piston assembly of integral type can be provided with a recess or a groove for cooperating with the annular central step, so as to seal the valve port.

It should be understood that when the piston assembly is an integral member, the structures of integral piston assembly are substantially identical with the piston assembly of FIG. 6. The only difference is not a clearance fit between the piston body and the seal plug, but is a tightly fixed connection or an integral die-casting. Therefore, it can be known from the above description about the operational principle that the piston assembly of the second embodiment needs to generate a pressure differential force on both the upper and lower surfaces thereof, so that the whole of the piston assembly will be pushed to move up.

It should be noted that, inertial principle is several times utilized in the first and second embodiments of the present invention, so that the movable core and the piston body or the piston assembly all are used to open the conducting hole or the valve port when they get a relatively large momentum.

Although some embodiments of the general inventive concept are illustrated and explained, it would be appreciated by those skilled in the art that modifications and variations may be made in these embodiments without departing from the principles and spirit of the general inventive concept of the disclosure, the scope of which is defined in the claims and equivalents thereof.

1. A solenoid valve, comprising:
a movable core, provided with a flange at a lower end thereof;
a driving assembly, in which the flange is configured to abut against a bottom portion of the driving assembly and can move within a chamber of the driving assembly until it abuts against an upper portion of the driving assembly;
a piston assembly, a central part of which seals a valve port of the solenoid valve, and a periphery of which seals an annular chamber formed between the valve port and a valve body of the solenoid valve, the annular chamber being communicated to an inlet connection pipe, the piston assembly being disposed with a conducting hole at a center thereof, the conducting hole being sealed by the bottom of the driving assembly;
when opening the valve port, the flange of the movable core will first be moved to abut against the upper portion of the driving assembly, and then drive the driving assembly to move up in order to open the conducting hole, wherein since flow of fluid from an upper chamber above the piston assembly into an valve body outlet chamber below the piston assembly through the conducting hole via the valve port is larger than flow of fluid into the upper chamber from the inlet connection pipe of the solenoid valve, an upward force of pressure difference is generated on the piston assembly so that such upward force enables the piston assembly to move up, thereby opening the valve port.

2. The solenoid valve of claim 1, wherein,
a seal member is disposed on a bottom portion of the driving assembly at a center thereof, for sealing the conducting hole; and a bottom portion of the driving assembly is a circular bottom plate, which is provided with a plurality of grooves spaced apart along an outer periphery thereof and a plurality of protrusions between the adjacent grooves.

3. The solenoid valve of claim 2, wherein,
a top plate of the driving assembly has a smaller diameter than the bottom plate, and is an arc-shaped flat plate, and the top plate is integrated with the bottom plate by a vertical wall, so as to form a cylindrical chamber with a portion thereof being cut away at one side thereof.

4. The solenoid valve of claim 3, wherein,
an opening is provided at a center of the top plate, a top of the opening is in an arc shape, and two sides of the opening are vertical, and two sides of the vertical wall are internally cut so as to form flat straight sides at the interior of the vertical wall, for receiving and connecting with the flange of the movable core.

5. The solenoid valve of claim 4, wherein,
the seal member is a hemisphere used for sealing the conducting hole, a spherical surface of the hemisphere is cooperated with the conducting hole, and a large circular surface or a bottom surface of the hemisphere passing through an center thereof is in the same horizontal plane as a plane of the bottom plate, and a plurality of ventholes spaced apart are provided along a circumference of the circular surface or the bottom surface.

6. The solenoid valve of claim 5, wherein,
the driving assembly is integrally or separately made of plastics.

7. The solenoid valve of claim 1, wherein,
the piston assembly is of an integral type, an upper part of the piston assembly is provided with an annular slot at a central part thereof, while a lower portion of the piston assembly is arranged with a boss, or a groove inwardly recessed, an outer surface of the piston assembly is provided with a plurality of tooth slots, and fluid flows into the valve body of the solenoid valve through a gap between the tooth slots and the valve seat of the solenoid valve.

8. The solenoid valve of claim 7, wherein,
when the seal member of the driving assembly seals the conducting hole of the piston assembly, the boss of the piston assembly or a portion of the bottom surface of the piston assembly and the groove will be fitted on an annular central step disposed within the chamber of the valve body, so that the piston assembly seals the valve port.

9. The solenoid valve of claim 8, wherein,
a bottom surface of the piston assembly is provided with an inclined surface which gradually rises from an inside to an outside, when the seal member of the driving assembly seals the conducting hole of the piston assembly, since the bottom surface of the piston assembly is inclined, only a portion of the bottom surface of the piston assembly abuts against the annular central step arranged in the chamber of the valve body, and an outside portion of the bottom surface of the piston assembly abuts against the annular central step, and thus the piston assembly seals the valve port.

10. The solenoid valve of claim 1, wherein,
the piston assembly is of separate type, and includes a piston body and a seal plug which can be assembled together to be movable relative to each other.

11. The solenoid valve of claim 10, wherein,
a central chamber of the piston body is a two-stage cylindrical step chamber, an upper step chamber of which has a larger diameter than a lower step chamber of the two-stage cylindrical step chamber, wherein an upper portion of the seal plug is a cylinder with a protrusion at an upper portion, which protrusion has an outer diameter larger than the diameter of the lower step chamber and less than the diameter of the upper step chamber, so that the protrusion can be locked within the two-stage cylindrical step chamber.

12. The solenoid valve of claim 11, wherein,
the seal plug can be moved up within the central chamber of the piston body along a central axis thereof, a distance between an upper end face of the seal plug and an upper end face of the piston body is a first distance so that an annular groove is formed within an upper portion of the piston assembly, and a bottom portion of the seal plug is protruded from the central chamber of the piston body by a second distance to form a boss, or is recessed inwardly by a second distance to form a groove.

13. The solenoid valve of claim 12, wherein,
an outer surface of the piston body is provided with a plurality of tooth slots, fluid flows into the valve body of the solenoid valve through a gap between the tooth slots and the valve seat of the solenoid valve, and a bottom surface of the piston body is provided with an inclined surface which gradually rises from an inside to an outside.

14. The solenoid valve of claim 13, wherein,
when the seal member of the driving assembly seals the conducting hole of the seal plug, since the bottom surface of the piston body is inclined, only a portion of the bottom surface of the piston body abuts against the annular central step arranged in the chamber of the valve body, and an outside portion of the bottom surface of the seal plug abuts against the annular central step, and thus the seal plug seals the valve port.

15. The solenoid valve of claim 14, wherein,
the annular valve port is formed within the valve body by arrangement of the annular central step in the valve body, the annular chamber is formed between the annular central step and the body of the valve seat, and the piston body covers on the annular chamber, which is communicated to the inlet connection pipe of the solenoid valve.

16. The solenoid valve of claim 15, wherein,
when the conducting hole of the seal plug is opened, since flow into the upper chamber above the piston body through the gap between the tooth slots and the valve seat is less than flow into the valve body outlet chamber below the piston assembly and a chamber of the outlet connection pipe from the upper chamber through the conducting hole, the upper chamber becomes a low pressure chamber, and the annular chamber becomes a high pressure chamber due to communicating to the chamber of the inlet connection pipe of the solenoid valve, thereby an upward force of pressure difference is generated on the piston body, the upward force drives the piston body to move up until it abuts against the protrusion of the seal plug, and then drives the seal plug and the piston body to move up together, until the valve port is finally opened.

17. The solenoid valve of claim 1, further comprising:
a valve body having a fixed core, a sleeve, the movable core, a valve seat, the driving assembly, the piston assembly, and the inlet and outlet connection pipes cooperated with each other; and
a coil, disposed outside of the valve body corresponding to the fixed core, and capable of generating a magnetic force for attracting the movable core to move up, when being energized.

18. The solenoid valve of claim 17, wherein,
the valve seat is tightly connected to the sleeve by a seal cap arranged thereon and a seal ring provided at a bottom portion of the sleeve; the movable core is movably disposed within the sleeve, the valve seat is provided with the valve port, and the piston assembly seals the valve port of the valve seat, by which the inlet and outlet connection pipes are in fluid communication with the chamber of the valve seat.

19. The solenoid valve of claim 18, wherein,
a return spring is provided within the chamber of the movable core, one end of which is positioned in the chamber of the movable core, while the other end thereof is protruded from the chamber of the movable core and is contacted or fixed with a bottom surface of the fixed core, and a distance by which the movable core moves until it contacts with the fixed core is a first travel.

20. The solenoid valve of claim 19, wherein,
a distance by which the flange of the movable core moves within the chamber of the driving assembly from a bottom thereof until it abuts against a top of the chamber is a second travel, and the second travel is less than the first travel.
